(19) United States
(12) Patent Application Publication
(10) Pub. No.: US 2025/0100236 A1
(43) Pub. Date: Mar. 27, 2025

(54) Unitary Composite Structure

(71) Applicant: The Boeing Company, Arlington, VA (US)

(72) Inventors: James Goldberg, Mukilteo, WA (US); Troy Winfree, Seattle, WA (US); Brice Aaron Johnson, Toledo, WA (US); Adriana Willempje Blom-Schieber, Snohomish, WA (US)

(21) Appl. No.: 18/678,676

(22) Filed: May 30, 2024

Related U.S. Application Data
(60) Provisional application No. 63/584,694, filed on Sep. 22, 2023.

(51) Int. Cl. B29C 70/32; B29C 70/54; B29L 31/00; F17C 1/16

(52) U.S. Cl. CPC B29C 70/32; B29C 70/54; F17C 1/16; B29L 2031/7156; F17C 2201/0109; F17C 2203/0673; F17C 2209/2163; F17C 2209/232

(57) ABSTRACT

A unitary composite structure and methods of forming are presented. A method of laying up a unitary composite structure comprises laying up a plurality of dome plies on a rounded end of a mandrel using a plurality of rosettes; laying up a plurality of cylindrical plies on a cylindrical surface of the mandrel using a layup rosette independent of the plurality of rosettes; and forming a transition region comprising a joint between the plurality of dome plies and the plurality of cylindrical plies by varying lengths of the plurality of dome plies and lengths of the plurality of cylindrical plies.

### CROSS-REFERENCE TO RELATED APPLICATION

This application claims the benefit of U.S. Provisional Patent Application Ser. No. 63/584,694, filed Sep. 22, 2023, and entitled “Unitary Composite Structure,” which is incorporated herein by reference in its entirety.

### BACKGROUND INFORMATION

### 1. Field

The present disclosure relates generally to composites manufacturing and more specifically to the formation of a composite structure comprising a dome portion and a cylindrical portion.

### 2. Background

Reducing weight is a concern for the storage, manufacture, or transport of different structures. For example, it is desirable to reduce the weight of aircraft components such as fuel tanks. To reduce weight of components, such as pressure tanks, it can be desirable to manufacture components from composite materials.

Composite materials are strong, light-weight materials created by combining two or more functional components. For example, a composite material may include reinforcing fibers bound in polymer resin matrix. The fibers can take the form of a unidirectional tape, woven cloth or fabric, or a braid. The mechanical properties and other material properties of composite materials can be desirable for some implementations. For example, buoyancy of composite materials can be more desirable for submersible applications.

Therefore, it would be desirable to have a method and apparatus that takes into account at least some of the issues discussed above, as well as other possible issues.

### SUMMARY

An embodiment of the present disclosure provides a method of laying up a unitary composite structure. A plurality of dome plies are laid up on a rounded end of a mandrel using a plurality of rosettes. A plurality of cylindrical plies are laid up on a cylindrical surface of the mandrel using a layup rosette independent of the plurality of rosettes. A transition region is formed, the transition region comprising a joint between the plurality of dome plies and the plurality of cylindrical plies by varying lengths of the plurality of dome plies and lengths of the plurality of cylindrical plies.

Another embodiment of the present disclosure provides a unitary composite structure. The unitary composite structure comprises a dome portion comprising a plurality of sets of plies laid up using a plurality of rosettes; a cylindrical portion laid up with a layup rosette independent of the plurality of rosettes; and a transition region between the dome portion and the cylindrical portion formed by varying lengths of plurality of dome plies of the dome portion and varying lengths of plurality of cylindrical plies of the cylindrical portion.

A further embodiment of the present disclosure provides a method of laying up a composite structure. A plurality of dome plies is laid up on a rounded end of a mandrel. Laying up the plurality of dome plies comprises laying up a first set of plies on a rounded end of a mandrel at a zero degree fiber angle using a first rosette; laying up a second set of plies on the rounded end of the mandrel at a zero degree fiber angle using a second rosette offset from the first rosette; and laying up a third set of plies on the rounded end of the mandrel at a zero degree fiber angle using a third rosette offset from both the first rosette and the second rosette. A plurality of cylindrical plies is laid up on a cylindrical surface of the mandrel in contact with the plurality of dome plies. Lengths of the plurality of dome plies and the plurality of cylindrical plies are varied to form a joint between the plurality of dome plies and the plurality of cylindrical plies.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a manufacturing environment in accordance with an illustrative embodiment;

FIG. 2 is an illustration of an isometric view of a unitary composite structure on a mandrel in accordance with an illustrative embodiment;

FIG. 3 is an illustration of a front view of a ply of a dome portion of a composite structure in accordance with an illustrative embodiment;

FIG. 4 is an illustration of a front view of a ply of a dome portion of a composite structure in accordance with an illustrative embodiment;

FIG. 5 is an illustration of a front view of a ply of a dome portion of a composite structure in accordance with an illustrative embodiment;

FIG. 6 is an illustration of an isometric view of composite plies laid up on a mandrel in accordance with an illustrative embodiment;

FIG. 7 is an illustration of an isometric view of composite plies laid up on a mandrel in accordance with an illustrative embodiment;

FIG. 8 is a flowchart of a method of laying up a unitary composite structure in accordance with an illustrative embodiment;

FIG. 9 is a flowchart of a method of laying up a composite structure in accordance with an illustrative embodiment;

FIG. 10 is an illustration of an aircraft manufacturing and service method in a form of a block diagram in accordance with an illustrative embodiment; and

FIG. 11 is an illustration of an aircraft in a form of a block diagram in which an illustrative embodiment may be implemented.

### DETAILED DESCRIPTION

The illustrative examples take into account one or more considerations. The illustrative examples take into account that current dome fabrication uses a standard rosette orientation methodology and domes and cylinders are fabricated separately. The illustrative examples recognize and take into account that large domes allow for steering of the cylinder (standard orientation) plies onto a dome region. The illustrative examples recognize and take into account that a steering radius using the standard rosette orientation methodology on smaller dome structures becomes small enough to produce undesirable effects in the domes. The illustrative examples also recognize and take into account that conventional fiber placement paths that transition onto the dome surface have a singularity at the poles of the dome resulting in unacceptable results. The illustrative examples provide methods of forming and a unitary composite structure that can be formed with smaller dome diameters without undesirable effects. The illustrative examples provide methods and a unitary composite structure formed without singularities at the poles. The illustrative examples provide methods of forming a unitary composite structure having a half capsule shape.

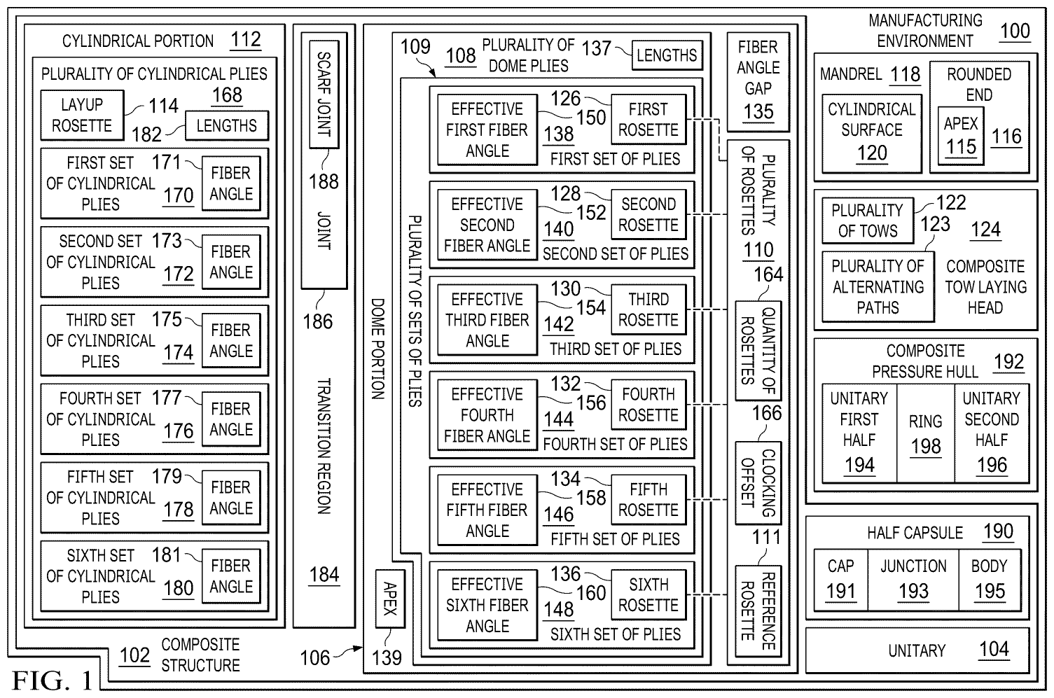

Turning now to FIG. 1, an illustration of a block diagram of a manufacturing environment is depicted in accordance with an illustrative embodiment. Unitary 104 composite structure 102 is manufactured in manufacturing environment 100. Unitary 104 composite structure 102 comprises dome portion 106 comprising plurality of sets of plies 109 laid up using plurality of rosettes 110, and cylindrical portion 112 laid up with layup rosette 114 independent of plurality of rosettes 110. In some illustrative examples, the layup rosette 114 is projected onto surface such that the y-axis extends longitudinally along mandrel 118 and x-axis extends in a circumferential direction.

Layup rosette 114 for cylindrical portion 112 comprises an axis in a reference coordinate system. In some illustrative examples, an X-axis can be used for the zero reference. Any axis of layup rosette 114 can be used for the zero reference. The axis can be anywhere in space. In some illustrative examples, the axis is the axis of symmetry for mandrel 118.

In some illustrative examples, the reference axis is projected onto cylindrical surface 120 at a point, to define the 0 direction on cylindrical surface 120. The fiber angle is then rotated about that local point from the 0 projection, about a surface normal, to determine the path direction at that point.

Unitary 104 composite structure 102 is laid up on mandrel 118. Mandrel 118 comprises rounded end 116 and cylindrical surface 120. Dome portion 106 is laid up on rounded end 116 of mandrel 118. Cylindrical portion 112 is laid up on cylindrical surface 120.

Dome portion 106 comprises plurality of dome plies 108 laid up on rounded end 116 of mandrel 118. Plurality of dome plies 108 are laid up entirely on rounded end 116 of mandrel 118. Cylindrical portion 112 comprises plurality of cylindrical plies 168 laid up on cylindrical surface 120. At least one cylindrical ply of plurality of cylindrical plies 168 extends onto rounded end 116 of mandrel 118. Portions of plurality of cylindrical plies 168 that extend onto rounded end 116 form transition region 184.

In some illustrative examples, a cylindrical ply of plurality of cylindrical plies 168 is a composite ply that is generally started on cylindrical surface 120 and transitions to a portion of rounded end 116 of mandrel 118. In some illustrative examples, many of plurality of cylindrical plies 168 will continue onto rounded end 116 of mandrel 118. In some illustrative examples, all of plurality of cylindrical plies 168 will continue onto rounded end 116 of mandrel 118. Material characteristics of plurality of dome plies 108 may be undesirable at the edge of rounded end 116 where rounded end 116 meets cylindrical surface 120. Accordingly, plurality of dome plies 108 can be laid up on rounded end 116 and terminate prior to an intersection with cylindrical surface 120.

In some illustrative examples, each rosette of plurality of rosettes 110 has a Z-axis extending into apex 115 of rounded end 116 of mandrel 118. In some illustrative examples, each rosette of plurality of rosettes 110 has a Z-axis extending parallel to cylindrical surface 120 of mandrel 118. In some illustrative examples, each rosette of plurality of rosettes 110 has a Z-axis that is perpendicular to plurality of dome plies 108 over apex 115 of rounded end 116 of mandrel 118.

Plurality of rosettes 110 comprises rosettes rotated about the z-axis extending into or away from apex 115. In some illustrative examples, the rotating about the Z-axis can be referred to as “clocking”. In some illustrative examples, plurality of rosettes 110 comprises reference rosette 111 and a number of rosettes clocked about the Z-axis relative to the reference rosette. In some illustrative examples, the reference rosette is positioned to layup zero degree fiber angle plies in composite structure 102.

In some illustrative examples, reference rosette 111 is oriented such that a Z-axis is normal to apex 115 of rounded end 116 of mandrel 118. In some illustrative examples, reference rosette 111 is oriented such that a Z-axis is parallel to a longitudinal axis of cylindrical surface 120 of mandrel 118. The x-axis and y-axis of reference rosette 111 can have any desirable directions. In some illustrative examples, reference rosette 111 is oriented such that one axis is parallel to a Z-axis of layup rosette 114. In some illustrative examples, the reference rosette has a Y-axis perpendicular to a manufacturing floor. In some illustrative examples, the reference rosette had an X-axis parallel to the manufacturing floor.

A rosette is an orientation for laying up plurality of tows 122 by composite tow laying head 124. Prior to laying plurality of tows 122 on mandrel 118, composite tow laying head 124 positions itself relative to mandrel 118 using a respective rosette of plurality of rosettes 110.

Plurality of rosettes 110 can comprise any desirable quantity of rosettes 164. In some illustrative examples, plurality of rosettes 110 comprises at least four rosettes. As depicted, plurality of rosettes 110 comprises six rosettes, first rosette 126, second rosette 128, third rosette 130, fourth rosette 132, fifth rosette 134, and sixth rosette 136. In some illustrative examples, plurality of rosettes 110 comprises more than six rosettes. In some illustrative examples, dome portion 106 comprises a quantity of fiber angles equal to a quantity of rosettes 164 in plurality of rosettes 110.

In some illustrative examples, a separation between each of plurality of rosettes 110 is determined by dividing one hundred and eighty degrees into equal increments to set clocking offset 166 for plurality of rosettes 110. In one illustrative example, when quantity of rosettes 164 comprises four rosettes, clocking offset 166 is 180/4 or 45 degrees. In this illustrative example, plurality of rosettes 110 comprises 0 degrees, 45 degrees, 90 degrees, and 135 degrees. In one illustrative example, when quantity of rosettes 164 is six rosettes, clocking offset 166 is 180/6 or 30 degrees. In this illustrative example, plurality of rosettes 110 comprises 0 degrees, 30 degrees, 60 degrees, 90 degrees, 120 degrees, and 150 degrees. In another illustrative example, when quantity of rosettes 164 is eight rosettes, clocking offset 166 is 180/8 or 22.5 degrees. In this illustrative example, plurality of rosettes 110 comprises 0 degrees, 22.5 degrees, 45 degrees, 67.5 degrees, 90 degrees, 112.5 degrees, 135 degrees, and 157.5 degrees.

Dome portion 106 comprises plurality of dome plies 108. Plurality of dome plies comprises plurality of sets of plies 109.

Plurality of sets of plies 109 comprises first set of plies 138, second set of plies 140, third set of plies 142, fourth set of plies 144, fifth set of plies 146, and sixth set of plies 148. Although the terms “first”, “second”, “third”, “fourth”, “fifth”, and “sixth” are used, these terms do not indicate an order or sequence. Each of first set of plies 138, second set of plies 140, third set of plies 142, fourth set of plies 144, fifth set of plies 146, and sixth set of plies 148 can be laid up in any desirable order. Additionally, each of first set of plies 138, second set of plies 140, third set of plies 142, fourth set of plies 144, fifth set of plies 146, and sixth set of plies 148 can have any desirable quantity of plies per set. Although plurality of dome plies 108 is illustrated as comprising first set of plies 138, second set of plies 140, third set of plies 142, fourth set of plies 144, fifth set of plies 146, and sixth set of plies 148, any desirable quantity of sets of plies can be included in plurality of dome plies 108.

In some illustrative examples, each dome ply of plurality of dome plies 108 comprises plurality of alternating paths 123 of plurality of tows 122. Each path of plurality of alternating paths 123 comprises plurality of tows 122. In some illustrative examples, plurality of tows 122 comprises sixteen tows. Plurality of tows 122 comprises any desirable quantity of tows.

Each respective set of dome plies is laid up using a respective rosette of plurality of rosettes 110. First set of plies 138 is laid up using first rosette 126. First set of plies 138 is laid up at a zero degree fiber angle relative to first rosette 126. First rosette 126 is any desirable rosette of plurality of rosettes 110. By laying up first set of plies 138 according to first rosette 126, first set of plies 138 has effective first fiber angle 150. First set of plies 138 has effective first fiber angle 150 relative to reference rosette 111. In some illustrative examples, first rosette 126 is the same as reference rosette 111. In some illustrative examples, when first rosette 126 is the same as reference rosette 111, effective first fiber angle 150 is zero degrees. In some illustrative examples, when first rosette 126 is a rosette other than reference rosette 111, effective first fiber angle 150 is an angle other than zero degrees.

Second set of plies 140 is laid up using second rosette 128. Second set of plies 140 is laid up at zero degrees relative to second rosette 128. By laying up second set of plies 140 according to second rosette 128, second set of plies 140 has effective second fiber angle 152. In some illustrative examples, second rosette 128 is clocked relative to reference rosette 111. When second rosette 128 is clocked relative to reference rosette 111, effective second fiber angle 152 is a non-zero fiber angle relative to reference rosette 111. As depicted, quantity of rosettes 164 is six, and effective second fiber angle 152 can be one of 30 degrees, 60 degrees, 90 degrees, 120 degrees, or 150 degrees. In some illustrative examples, effective second fiber angle 152 is 30 degrees.

Third set of plies 142 is laid up using third rosette 130. Third set of plies 142 is laid up at zero degrees relative to third rosette 130. By laying up third set of plies 142 according to third rosette 130, third set of plies 142 has effective third fiber angle 154. In some illustrative examples, third rosette 130 is clocked relative to reference rosette 111. When third rosette 130 is clocked relative to reference rosette 111, effective third fiber angle 154 is a non-zero fiber angle relative to reference rosette 111. As depicted, quantity of rosettes 164 is six, and effective third fiber angle 154 can be one of 30 degrees, 60 degrees, 90 degrees, 120 degrees, or 150 degrees. In some illustrative examples, effective third fiber angle 154 is 60 degrees. In some illustrative examples, fiber angles of dome portion 106 are approximately equally offset from each other.

Fourth set of plies 144 is laid up using fourth rosette 132. Fourth set of plies 144 is laid up at zero degrees relative to fourth rosette 132. By laying up fourth set of plies 144 according to fourth rosette 132, fourth set of plies 144 has effective fourth fiber angle 156. In some illustrative examples, fourth rosette 132 is clocked relative to reference rosette 111. When fourth rosette 132 is clocked relative to reference rosette 111, effective fourth fiber angle 156 is a non-zero fiber angle relative to reference rosette 111. As depicted, quantity of rosettes 164 is six, and effective fourth fiber angle 156 can be one of 30 degrees, 60 degrees, 90 degrees, 120 degrees, or 150 degrees. In some illustrative examples, effective fourth fiber angle 156 is 90 degrees.

Fifth set of plies 146 is laid up using fifth rosette 134. Fifth set of plies 146 is laid up at zero degrees relative to fifth rosette 134. By laying up fifth set of plies 146 according to fifth rosette 134, fifth set of plies 146 has effective fifth fiber angle 158. In some illustrative examples, fifth rosette 134 is clocked relative to reference rosette 111. When fifth rosette 134 is clocked relative to reference rosette 111, effective fifth fiber angle 158 is a non-zero fiber angle relative to reference rosette 111. As depicted, quantity of rosettes 164 is six, and effective fifth fiber angle 158 can be one of 30 degrees, 60 degrees, 90 degrees, 120 degrees, or 150 degrees. In some illustrative examples, effective fifth fiber angle 158 is 120 degrees.

Sixth set of plies 148 is laid up using sixth rosette 136. Sixth set of plies 148 is laid up at zero degrees relative to sixth rosette 136. By laying up sixth set of plies 148 according to sixth rosette 136, sixth set of plies 148 has effective sixth fiber angle 160. In some illustrative examples, sixth rosette 136 is clocked relative to reference rosette 111. When sixth rosette 136 is clocked relative to reference rosette 111, effective sixth fiber angle 160 is a non-zero fiber angle relative to reference rosette 111. As depicted, quantity of rosettes 164 is six, and effective sixth fiber angle 160 can be one of 30 degrees, 60 degrees, 90 degrees, 120 degrees, or 150 degrees. In some illustrative examples, effective sixth fiber angle 160 is 150 degrees.

Each of effective first fiber angle 150, effective second fiber angle 152, effective third fiber angle 154, effective fourth fiber angle 156, effective fifth fiber angle 158, and effective sixth fiber angle 160 is laid down using respective rosettes. Due to using the respective rosettes, steering is at least one of reduced or eliminated in laying down dome portion 106. Each of effective first fiber angle 150, effective second fiber angle 152, effective third fiber angle 154, effective fourth fiber angle 156, effective fifth fiber angle 158, and effective sixth fiber angle 160 is laid down without steering the fibers. Steering in dome portion 106 can result in one edge of the tow being shorter or longer than the other edge of a tow. By reducing or eliminating steering, inconsistencies such as wrinkling, puckering, or fiber lifting are also reduced or eliminated in dome portion 106.

In some illustrative examples, plurality of dome plies 108 is laid up so that a substantially equal quantity of plies is laid up with each effective fiber angle. In some illustrative examples, plurality of dome plies 108 is laid up so that a substantially equal quantity of plies is laid up with each rosette of plurality of rosettes 110.

Cylindrical portion 112 is laid up with layup rosette 114. Layup rosette 114 is independent of plurality of rosettes 110. Each of plurality of cylindrical plies 168 of cylindrical portion 112 is laid up using layup rosette 114. Fiber steering can be performed to lay up a plurality of different fiber angles for cylindrical portion 112 with layup rosette 114. In some illustrative examples, fiber steering occurs in laying up sections of cylindrical portion 112 with non-zero ply angles that extend onto rounded end 116 of mandrel 118.

First set of cylindrical plies 170 is laid up according to layup rosette 114 to have fiber angle 171. Fiber angle 171 can have any desirable fiber angle for a design of composite structure 102. In some illustrative examples, fiber angle 171 is selected from zero degrees, 45 degrees, and 90 degrees.

Second set of cylindrical plies 172 is laid up according to layup rosette 114 to have fiber angle 173. Fiber angle 173 can be any desirable fiber angle for a design of composite structure 102. In some illustrative examples, fiber angle 173 can be the same as fiber angle 171. In some illustrative examples, fiber angle 173 is different from fiber angle 171.

Third set of cylindrical plies 174 is laid up according to layup rosette 114 with fiber angle 175. Fourth set of cylindrical plies 176 is laid up according to layup rosette 114 with fiber angle 177. Fifth set of cylindrical plies 178 is laid up according to layup rosette 114 with fiber angle 179. Sixth set of cylindrical plies 180 is laid up according to layup rosette 114 with fiber angle 181.

In some illustrative examples, plurality of cylindrical plies 168 is laid up such that each cylindrical ply overlaps a prior dome ply. In some illustrative examples, first set of cylindrical plies 170 is laid up to cover edges of first set of plies 138.

Unitary 104 composite structure 102 further comprises transition region 184 between dome portion 106 and cylindrical portion 112 formed by varying lengths 137 of plurality of dome plies 108 of dome portion 106 and varying lengths 182 of plurality of cylindrical plies 168 of cylindrical portion 112. In some illustrative examples, varying lengths 137 of plurality of dome plies 108 of dome portion 106 and varying lengths 182 of plurality of cylindrical plies 168 of cylindrical portion 112 forms joint 186 within transition region 184. In some illustrative examples, transition region 184 comprises joint 186. In some illustrative examples, joint 186 takes the form of scarf joint 188.

Transition region 184 is laid up on rounded end 116 of mandrel 118. Transition region 184 can be located in any desirable portion on rounded end 116.

Dome portion 106 of unitary 104 composite structure 102 does not have a center hole at apex 139 of dome portion 106. In some illustrative examples, for a location system with an X-axis (0 degrees) extending through apex 139 and parallel to body 195 and a Y-axis (90 degrees) extending through junction 193, transition region 184 can be positioned in the range of 45 degrees to 75 degrees. In some illustrative example, transition region 184 is positioned in the range of 60 degrees to 75 degrees. In some illustrative examples, transition region 184 is positioned to control fiber angle gap 135. In some illustrative examples, transition region 184 is positioned to maintain fiber angle gap 135 at or below 45 degrees.

In some illustrative examples, transition region 184 comprises a double scarf joint formed by alternatingly laid sets of cylindrical plies and sets of dome plies. In some illustrative examples, transition region 184 comprises a double scarf joint formed by alternatingly laying sets of dome plies such as first set of plies 138, second set of plies 140, or other desirable sets of plurality of dome plies 108 and sets of cylindrical plies such as first set of cylindrical plies 170, second set of cylindrical plies 172, or other desirable sets of plurality of cylindrical plies 168.

In some illustrative examples, joint 186 is formed by a series of abutting plies of plurality of dome plies 108 and plies of plurality of cylindrical plies 168. In some illustrative examples, joint 186 comprises slightly gapping plies of plurality of dome plies 108 and plies of plurality of cylindrical plies 168.

In some illustrative examples, transition region 184 has a series of joints between plies at the same thickness. In these illustrative examples, transition region 184 includes at least one additional joint in addition to joint 186. In some illustrative examples, transition region 184 comprises a set of joints, including joint 186, that are staggered through the thickness of unitary 104 composite structure 102 and separated to minimize repetition at any location within transition region 184.

After laying up cylindrical portion 112, dome portion 106, and transition region 184 formed by dome portion 106 and cylindrical portion 112, composite structure 102 is cured. Dome portion 106 and cylindrical portion 112 are co-cured. In some illustrative examples, composite structure 102 can be described as having a shape of half capsule 190.

Half capsule 190 comprises body 195 and cap 191 with junction 193 between body 195 and cap 191. In some illustrative examples, junction 193 is a location in which the curvature changes. In some illustrative examples, body 195 is formed entirely by cylindrical portion 112. In some illustrative examples, cap 191 includes transition region 184. In some illustrative examples, cap 191 comprises dome portion 106, transition region 184, and a fraction of cylindrical portion 112.

Composite structure 102 can be a portion of composite pressure hull 192. In some illustrative examples, composite structure 102 can take the form of one of unitary first half 194 or unitary second half 196 of composite pressure hull 192. Composite pressure hull 192 comprises unitary first half 194 and unitary second half 196 joined by ring 198.

Fiber angle gap 135 is a measurement of how spread apart fibers are on a location. Fiber angle gap 135 has a maximum of nearly 180 degrees. Fiber angle gap 135 is a measurement of fiber angles through the thickness. In some illustrative examples, fiber angle gap 135 is a largest angle between fiber angles at any location on the surface. Undesirably large fiber angle gaps undesirably affect a strength of composite structure 102. In some illustrative examples, it is desirable to reduce fiber angle gap 135 through a design for composite structure 102. In some illustrative examples, fiber angle gap 135 increases moving from apex 115 towards the connection between rounded end 116 and cylindrical surface 120.

Fiber angle gap 135 can be managed by the order of layup for plurality of dome plies 108, sizes of plurality of dome plies 108, and quantity of rosettes 164. Laying up plurality of dome plies 108 with shorter dome plies can reduce fiber angle gap 135. Selection of which plies of plurality of cylindrical plies 168 to extend further on rounded end 116 of mandrel 118 also can be done to reduce fiber angle gap 135. Selection of specific fiber angles of cylindrical portion 112 to extend further onto rounded end 116 of mandrel 118 also can be done to reduce fiber angle gap 135. Laying up plurality of dome plies 108 using plurality of rosettes 110 with greater quantity of rosettes 164 can reduce fiber angle gap 135. In some illustrative examples, clocking offset 166 is selected to reduce fiber angle gap 135. In some illustrative examples, the fiber angles of plurality of dome plies 108 and desired structural conditions for composite structure 102 affect lengths 137 of plurality of dome plies 108. In some illustrative examples, fiber angle gap 135 of dome portion 106 is desirably equal to or less than 45 degrees. In some illustrative examples, to reduce fiber angle gap 135, quantity of rosettes 164 can be increased. In some illustrative examples, to reduce fiber angle gap 135, some cylindrical plies of plurality of cylindrical plies 168 can extend further onto rounded end 116 of mandrel 118.

The illustration of manufacturing environment 100 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, more than six sets of plies are present in plurality of dome plies 108. Plurality of dome plies 108 comprises any desirable quantity of plies divided into any desired plurality of sets.

Additionally, although composite structure 102 is described as having plurality of cylindrical plies 168 and shape of half capsule 190, composite structure 102 can have other desirable shapes. In some illustrative examples, a non-cylindrical portion can be connected to dome portion 106 by transition region 184. In some illustrative examples, one of a conic, ellipsoidal, or other contoured portion is present instead of cylindrical portion 112. In other words, mandrel 118 can have another shape other than cylindrical surface 120 while still having rounded end 116. In these illustrative examples, mandrel 118 can be used to form a composite structure 102 with a body having a shape other than a cylindrical shape.

Further, for some non-cylindrical shapes, transition region 184 can be located at least partially in the body of the composite structure. In these illustrative examples, transition region 184 can be located in any desirable portion on rounded end 116 or a body of the mandrel depending on steering, angle gap, angle deviation, and other characteristics from the design of the composite structure.

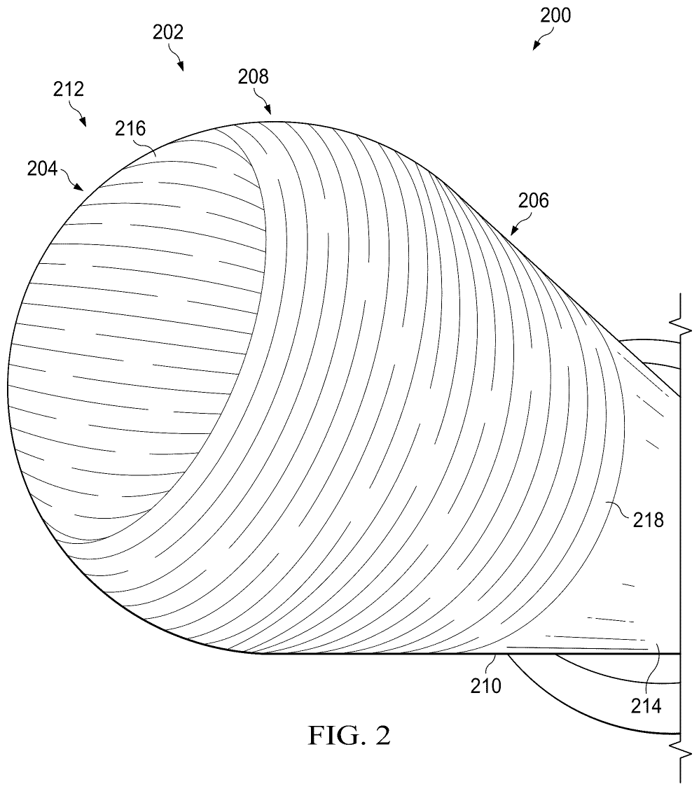

Turning now to FIG. 2, an illustration of a isometric view of a unitary composite structure on a mandrel is depicted in accordance with an illustrative embodiment. Unitary composite structure 202 is depicted in view 200. Unitary composite structure 202 is a physical implementation of unitary 104 composite structure 102 of FIG. 1.

Unitary composite structure 202 comprises dome portion 204 and cylindrical portion 206. Dome portion 204 comprises a plurality of sets of plies laid up using a plurality of rosettes. Cylindrical portion 206 is laid up with a layup rosette independent of the plurality of rosettes.

Unitary composite structure 202 further comprises transition region 208 between dome portion 204 and cylindrical portion 206 formed by varying lengths of plurality of dome plies 216 of dome portion 204 and varying lengths of plurality of cylindrical plies 218 of cylindrical portion that transition over to the dome portion 204. In some illustrative examples, transition region 208 comprises a double scarf joint formed by alternatingly laid sets of cylindrical plies and sets of dome plies.

In some illustrative examples, dome portion 204 comprises a quantity of fiber angles equal to a quantity of rosettes in the plurality of rosettes. In some illustrative examples, fiber angles of dome portion 204 are approximately equally offset from each other. In some illustrative examples, the plurality of rosettes comprises at least four rosettes. In some illustrative examples, a fiber angle gap of dome portion 204 is desirably equal to or less than 45 degrees.

Dome portion 204 is laid up on rounded end 212 of mandrel 210. Cylindrical portion 206 is laid up on cylindrical surface 214 of mandrel 210. Some cylindrical plies extend over portions of rounded end 212 of mandrel 210 to form transition region 208.

Although unitary composite structure 202 is described as having plurality of cylindrical plies forming cylindrical portion 206, a composite structure can be laid up according to the illustrative examples with a non-cylindrical body. In some illustrative examples, a composite structure can be one of a conic, ellipsoidal, or other contoured portion instead of cylindrical portion 206.

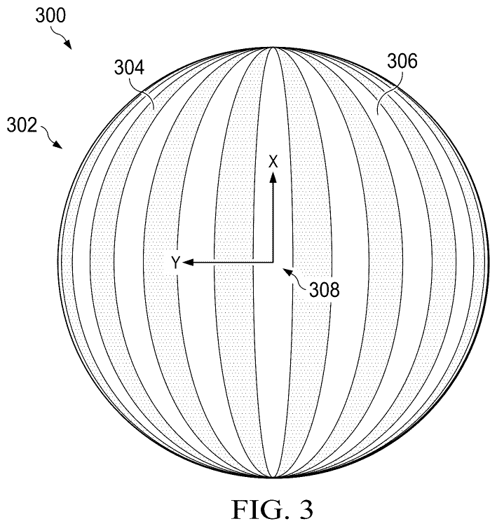

Turning now to FIG. 3, an illustration of a front view of a dome ply of a dome portion of a composite structure is depicted in accordance with an illustrative embodiment. Dome ply 302 in view 300 is a physical implementation of one of plurality of dome plies 108 of FIG. 1. In some illustrative examples, dome ply 302 has a larger surface area than a ply of plurality of dome plies 108 of FIG. 1. The surface area of dome ply 302 can be adjusted based on a design of the composite structure and a desired fiber angle gap. In some illustrative examples, dome ply 302 is a physical implementation of a ply of first set of plies 138 of FIG. 1. Dome ply 302 can be present in unitary composite structure 202 of FIG. 2. Dome ply 302 comprises plurality of alternating paths 304 of plurality of tows 306. Each path of plurality of alternating paths 304 comprises plurality of tows 306. In some illustrative examples, plurality of tows 306 comprises sixteen tows. Plurality of tows 306 comprises any desirable quantity of tows.

Plurality of alternating paths 304 have been laid up using rosette 308. Rosette 308 is a physical implementation of any desirable rosette of plurality of rosettes 110 of FIG. 1. In some illustrative examples, rosette 308 is a physical implementation of first rosette 126 of FIG. 1. In this illustrative example, rosette 308 can be referred to as a reference rosette. In some illustrative examples, rosette 308 is oriented such that a Z-axis is normal to an apex of a rounded end of a mandrel. In some illustrative examples, rosette 308 is oriented such that a Z-axis is parallel to a longitudinal axis of the cylindrical surface of the mandrel. The x-axis and y-axis of rosette 308 can have any desirable directions. In some illustrative examples, rosette 308 is oriented such that one axis is parallel to a Z-axis of a cylinder rosette (not shown). Cylinder rosette is a rosette used to layup the cylindrical portion of a unitary composite structure.

In some illustrative examples, rosette 308 is oriented such that one axis is perpendicular to the manufacturing floor and one axis is parallel to the manufacturing floor. In some illustrative examples, rosette 308 is oriented such that a Z-axis is parallel to the cylindrical surface of a mandrel.

Dome ply 302 has a zero degree angle relative to rosette 308. Dome ply 302 has been laid up without steering plurality of tows 306. Dome ply 302 is able to be laid up without steering plurality of tows 306 due to dome ply 302 having the zero degree angle relative to rosette 308.

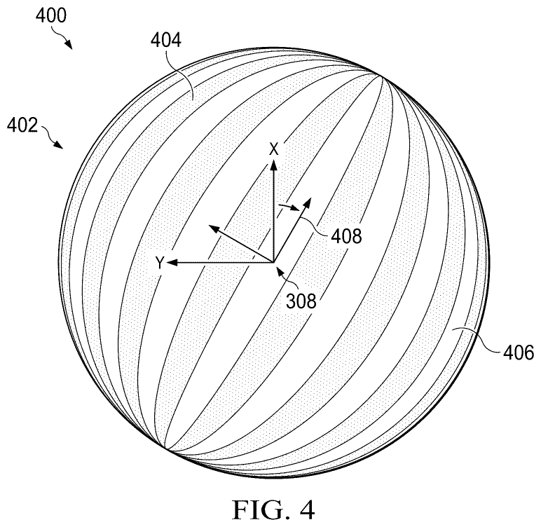

Turning now to FIG. 4, an illustration of a front view of a dome ply of a dome portion of a composite structure is depicted in accordance with an illustrative embodiment. Dome ply 402 in view 400 is a physical implementation of one of plurality of dome plies 108 of FIG. 1. In some illustrative examples, dome ply 402 has a larger surface area than a ply of plurality of dome plies 108 of FIG. 1. The surface area of dome ply 402 can be adjusted based on a design of the composite structure and a desired fiber angle gap. In some illustrative examples, dome ply 402 is a physical implementation of a ply of second set of plies 140 of FIG. 1. Dome ply 402 can be present in unitary composite structure 202 of FIG. 2. Dome ply 402 comprises plurality of alternating paths 404 of plurality of tows 406. Each path of plurality of alternating paths 404 comprises plurality of tows 406.

Plurality of alternating paths 404 have been laid up using rosette 408. Rosette 408 is a physical implementation of any desirable rosette of plurality of rosettes 110 of FIG. 1. In some illustrative examples, rosette 308 is a physical implementation of second rosette 128 of FIG. 1. In this illustrative example, rosette 408 has been rotated about the Z-axis relative to rosette 308. In some illustrative examples, the rotating about the Z-axis can be referred to as “clocking”. In this illustrative example, rosette 408 has been clocked approximately 22.5 degrees relative to rosette 308.

Dome ply 402 has a zero degree angle relative to rosette 408. Dome ply 402 has been laid up without steering plurality of tows 406 due to laying up dome ply 402 with the zero degree angle relative to rosette 408. Dome ply 402 has an effective ply angle of 22.5 degrees relative to rosette 308 without steering plurality of tows 406. Dome ply 402 can be referred to as a 22.5 degree ply.

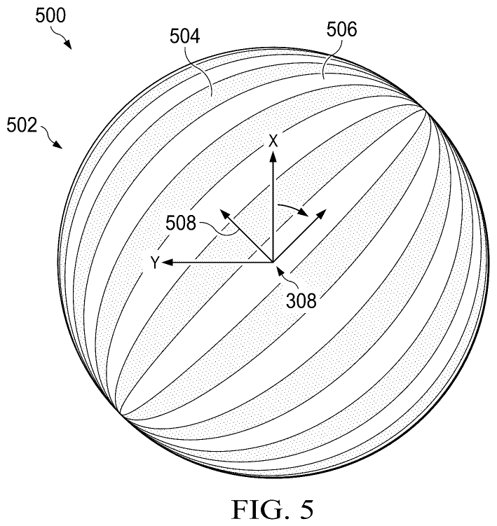

Turning now to FIG. 5, an illustration of a front view of a dome ply of a dome portion of a composite structure is depicted in accordance with an illustrative embodiment. Dome ply 502 in view 500 is a physical implementation of one of plurality of dome plies 108 of FIG. 1. In some illustrative examples, dome ply 502 has a larger surface area than a ply of plurality of dome plies 108 of FIG. 1. The surface area of dome ply 502 can be adjusted based on a design of the composite structure and a desired fiber angle gap. In some illustrative examples, dome ply 502 is a physical implementation of a ply of third set of plies 142 of FIG. 1. Dome ply 502 can be present in unitary composite structure 202 of FIG. 2. Dome ply 502 comprises plurality of alternating paths 504 of plurality of tows 506. Each path of plurality of alternating paths 504 comprises plurality of tows 506.

Plurality of alternating paths 504 have been laid up using rosette 508. Rosette 508 is a physical implementation of any desirable rosette of plurality of rosettes 110 of FIG. 1. In some illustrative examples, rosette 508 is a physical implementation of third rosette 130 of FIG. 1. In this illustrative example, rosette 508 has been clocked relative to rosette 308. In this illustrative example, rosette 508 has been clocked approximately 45 degrees relative to rosette 308.

Dome ply 502 has a zero degree fiber angle relative to rosette 508. Dome ply 502 has been laid up without steering plurality of tows 506. Dome ply 502 has an effective ply angle of 45 degrees relative to rosette 308 without steering plurality of tows 506. Dome ply 502 can be referred to as a 45 degree ply.

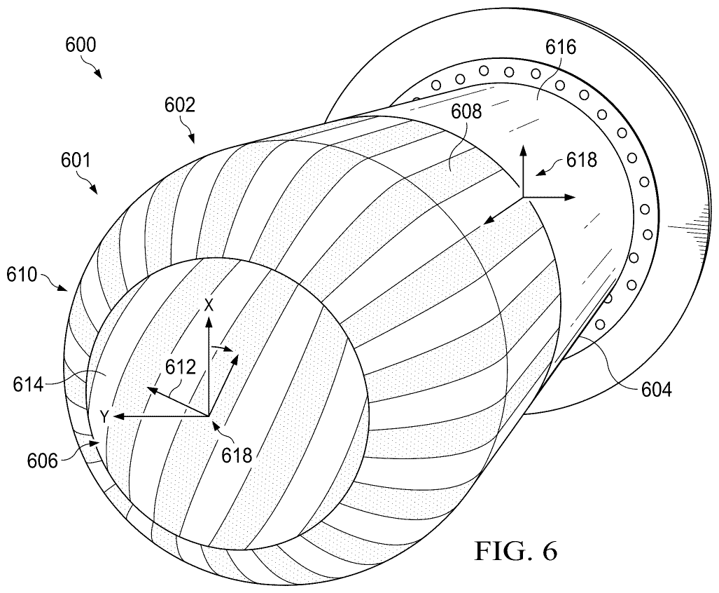

Turning now to FIG. 6, an illustration of an isometric view of composite plies laid up on a mandrel is depicted in accordance with an illustrative embodiment. In view 600 layup 601 comprises plurality of plies 602 laid up on mandrel 604. Layup 601 comprises at least one cylindrical ply of plurality of cylindrical plies 168 of FIG. 1 and at least one dome ply of plurality of dome plies 108 of FIG. 1. Layup 601 can be a portion of unitary composite structure 202 of FIG. 2. Dome ply 302 of FIG. 3 can be one ply of layup 601. Dome ply 402 of FIG. 4 can be one ply of layup 601. Dome ply 502 of FIG. 5 can be one ply of layup 601.

Plurality of plies 602 comprises dome ply 606 and cylindrical ply 608. In this illustrative example, cylindrical ply 608 is a zero degree ply. Transition region 610 is formed by interactions between dome plies on rounded end 614 of mandrel and cylindrical plies on cylindrical surface 616 of mandrel 604.

Dome ply 606 is laid up on rounded end 614 of mandrel 604 using rosette 612. Rosette 612 is clocked relative to reference rosette 618. By clocking rosette 612 relative to reference rosette 618, dome ply 606 has an effective fiber angle of approximately 22.5 degrees. By laying up dome ply 606 at a zero fiber angle relative to rosette 612, dome ply 606 is laid up at an effective fiber angle of 22.5 degrees without using fiber steering.

A dome portion of a unitary composite structure comprises a plurality of sets of dome plies laid up using a plurality of rosettes on rounded end 614 of mandrel 604. Dome ply 606 is one ply of the plurality of sets of dome plies of the dome portion.

Cylindrical ply 608 is laid up with a layup rosette independent of rosette 612, and parallel to the cylinders axis of symmetry. Cylindrical ply 608 is laid up with a layup rosette independent of the plurality of rosettes for laying up a dome portion on rounded end 614 of mandrel 604. As depicted in view 600, cylindrical ply 608 is laid up over the edges of dome ply 606.

In some illustrative examples, after laying up cylindrical ply 608, another cylindrical ply can be laid up over at least a portion of cylindrical ply 608. The another cylindrical ply can have any desirable fiber angle according to a design for the unitary composite structure. The another cylindrical ply will be laid up using a same layup rosette as cylindrical ply 608.

In some illustrative examples, after laying up cylindrical ply 608, another dome ply can be laid up over at least a portion of cylindrical ply 608. In some illustrative examples, after laying up cylindrical ply 608, another dome ply can be laid up abutting or with a slight gap with cylindrical ply 608. The another dome ply can have any desirable fiber angle according to a design for the unitary composite structure. In some illustrative examples, the another dome ply can be laid up using rosette 612. In some illustrative examples, the another dome ply can be laid up using a rosette different from rosette.

A transition region can be formed between the dome portion and the cylindrical portion formed by varying lengths of plurality of dome plies of the dome portion and varying lengths of plurality of cylindrical plies of the cylindrical portion. In some illustrative examples, a next cylindrical ply laid up over a portion of cylindrical ply 608 is shorter than cylindrical ply 608 to cover less of rounded end 614 of mandrel 604.

In some illustrative examples, the transition region comprises a double scarf joint formed by alternatingly laid sets of cylindrical plies on cylindrical surface and sets of dome plies. The transition region can include any desirable quantity of joints. In some illustrative examples, the transition region comprises a number of joints staggered through the thickness of the unitary composite structure.

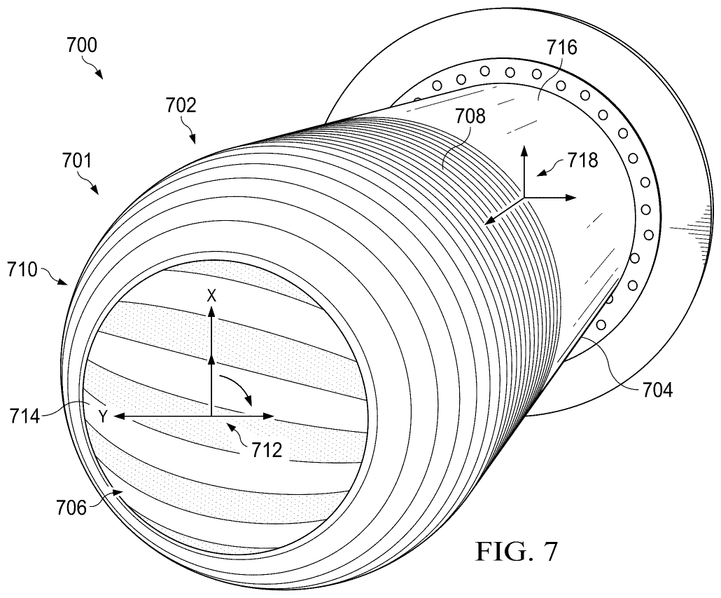

Turning now to FIG. 7, an illustration of an isometric view of composite plies laid up on a mandrel is depicted in accordance with an illustrative embodiment. In view 700 layup 701 comprises plurality of plies 702 laid up on mandrel 704. Layup 701 comprises at least one cylindrical ply of plurality of cylindrical plies 168 of FIG. 1 and at least one dome ply of plurality of dome plies 108 of FIG. 1. Layup 701 can be a portion of unitary composite structure 202 of FIG. 2. Dome ply 302 of FIG. 3 can be one ply of layup 701. Dome ply 402 of FIG. 4 can be one ply of layup 701. Dome ply 502 of FIG. 5 can be one ply of layup 701.

Plurality of plies 702 comprises dome ply 706 and cylindrical ply 708. In this illustrative example, cylindrical ply 708 is a ninety degree ply. Transition region 710 is formed by interactions between dome plies on rounded end 714 of mandrel and cylindrical plies on cylindrical surface 716 of mandrel 704.

Dome ply 706 is laid up on rounded end 714 of mandrel 704 using rosette 712. Rosette 712 is clocked relative to reference rosette 718. By clocking rosette 712 relative to reference rosette 718, dome ply 706 has an effective fiber angle of approximately 90 degrees. By laying up dome ply 706 at a zero fiber angle relative to rosette 712, dome ply 706 is laid up at an effective fiber angle of 90 degrees without using fiber steering.

A dome portion of a unitary composite structure comprises a plurality of sets of dome plies laid up using a plurality of rosettes on rounded end 714 of mandrel 704. Dome ply 706 is one ply of the plurality of sets of dome plies of the dome portion.

Cylindrical ply 708 is laid up with a layup rosette independent of rosette 712. Cylindrical ply 708 is laid up with a layup rosette independent of the plurality of rosettes for laying up a dome portion on rounded end 714 of mandrel 704. As depicted in view 700, cylindrical ply 708 is laid up over the edges of dome ply 706.

In some illustrative examples, after laying up cylindrical ply 708, another cylindrical ply can be laid up over at least a portion of cylindrical ply 708. The another cylindrical ply can have any desirable fiber angle according to a design for the unitary composite structure. The another cylindrical ply will be laid up using a same layup rosette as cylindrical ply 708.

In some illustrative examples, after laying up cylindrical ply 708, another dome ply can be laid up over at least a portion of cylindrical ply 708. In some illustrative examples, after laying up cylindrical ply 708, another dome ply can be laid up abutting or with a slight gap with cylindrical ply 708. The another dome ply can have any desirable fiber angle according to a design for the unitary composite structure. In some illustrative examples, the another dome ply can be laid up using rosette 712. In some illustrative examples, the another dome ply can be laid up using a rosette different from rosette.

A transition region can be formed between the dome portion and the cylindrical portion formed by varying lengths of plurality of dome plies of the dome portion and varying lengths of plurality of cylindrical plies of the cylindrical portion. In some illustrative examples, a next cylindrical ply laid up over a portion of cylindrical ply 708 is shorter than cylindrical ply 708 to cover less of rounded end 714 of mandrel 704.

In some illustrative examples, the transition region comprises a double scarf joint formed by alternatingly laid sets of cylindrical plies on cylindrical surface and sets of dome plies. The transition region can include any desirable quantity of joints. In some illustrative examples, the transition region comprises a number of joints staggered through the thickness of the unitary composite structure.

Although in FIGS. 6 and 7 the unitary composite structure is described as having plurality of cylindrical plies forming a cylindrical portion, a composite structure can be laid up according to the illustrative examples with a non-cylindrical body. In some illustrative examples, a composite structure can be one of a conic, ellipsoidal, or other contoured portion instead of a cylindrical portion.

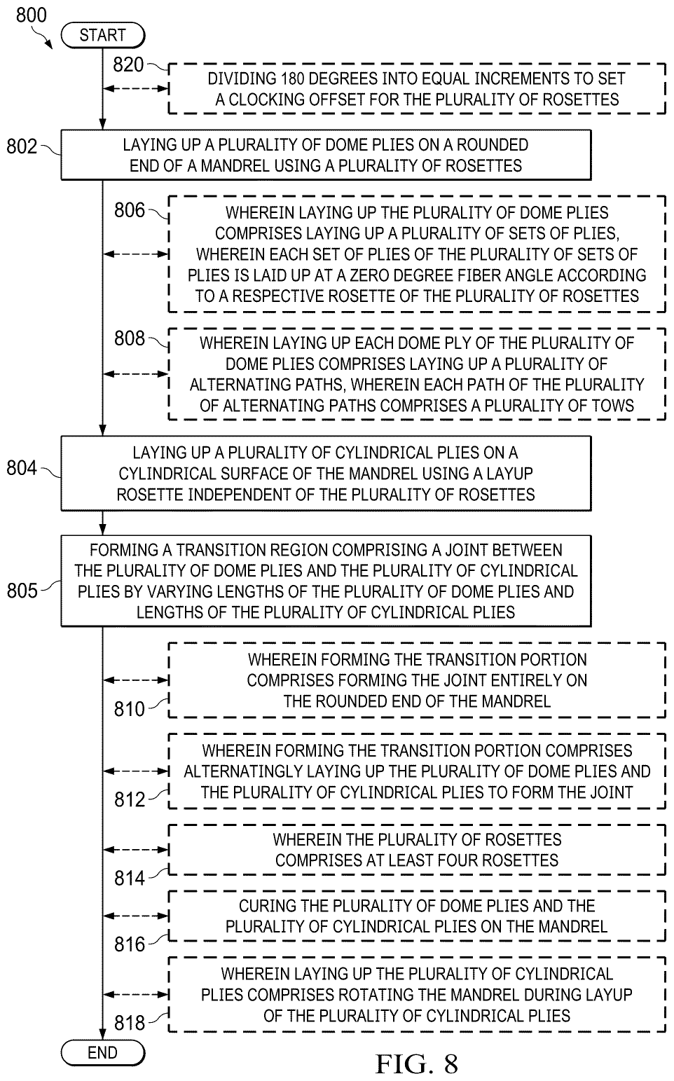

Turning now to FIG. 8, a flowchart of a method of laying up a unitary composite structure is depicted in accordance with an illustrative embodiment. Method 800 can be performed to layup unitary 104 composite structure 102 of FIG. 1. Method 800 can be performed to layup unitary composite structure 202 of FIG. 2. Laying up dome ply 302 of FIG. 3 can be done during method 800. Laying up dome ply 402 of FIG. 4 can be done during method 800. Laying up dome ply 502 of FIG. 5 can be done during method 800. Method 800 can be performed to form layup 601 of FIG. 6. Method 800 can be performed to form layup 701 of FIG. 7.

Method 800 lays up a plurality of dome plies on a rounded end of a mandrel using a plurality of rosettes (operation 802). Method 800 lays up a plurality of cylindrical plies on a cylindrical surface of the mandrel using a layup rosette independent of the plurality of rosettes (operation 804). Method 800 forms a transition region comprising a joint between the plurality of dome plies and the plurality of cylindrical plies by varying lengths of the plurality of dome plies and the plurality of cylindrical plies (operation 805). Afterwards, method 800 terminates.

In some illustrative examples, laying up the plurality of dome plies comprises laying up a plurality of sets of plies, wherein each set of plies of the plurality of sets of plies is laid up at a zero degree fiber angle according to a respective rosette of the plurality of rosettes (operation 806). By laying up each ply at a zero degree fiber angle relative to a respective rosette, each ply can be laid up with a desired effective fiber angle without undesirable amounts of fiber steering. Each set of plies comprises any desirable quantity of plies.

In some illustrative examples, laying up each dome ply of the plurality of dome plies comprises laying up a plurality of alternating paths, wherein each path of the plurality of alternating paths comprises a plurality of tows (operation 808). The plurality of tows comprises any desirable quantity of tows.

In some illustrative examples, forming the transition region comprises forming the joint entirely on the rounded end of the mandrel (operation 810). The lengths of the plurality of dome plies and the plurality of cylindrical plies can be varied by any desirable amount. In some illustrative examples, the lengths of the plurality of dome plies can be varied by approximately 0.5 inches.

In some illustrative examples, wherein forming the transition region comprises alternatingly laying up the plurality of dome plies and the plurality of cylindrical plies to form the joint (operation 812). Any desirable quantity of dome plies can be laid up prior to laying up cylindrical plies. Additionally, the quantity of dome plies laid up prior to laying up of a subsequent quantity of cylindrical plies is independent of other quantities of dome plies previously laid down.

In some illustrative examples, the plurality of rosettes comprises at least four rosettes (operation 814). In some illustrative examples, the plurality of rosettes comprises six rosettes. In some illustrative examples, the plurality of rosettes comprises more than six rosettes.

In some illustrative examples, method 800 cures the plurality of dome plies and the plurality of cylindrical plies on the mandrel (operation 816). The plurality of dome plies and the plurality of cylindrical plies are co-cured on the mandrel. By co-curing the plurality of dome plies and the plurality of cylindrical plies on the mandrel, a unitary composite structure with a dome portion, a cylindrical portion, and a transition region between the dome portion and the cylindrical portion is formed. By co-curing the plurality of dome plies and the plurality of plies on the mandrel, a unitary composite structure with a half capsule shape is formed.

In some illustrative examples, laying up the plurality of cylindrical plies comprises rotating the mandrel during layup of the plurality of cylindrical plies (operation 818). In some illustrative examples, rotating the mandrel allows a composite lay-up head to remain on a track.

In some illustrative examples, method 800 divides one hundred and eighty degrees into equal increments to set a clocking offset for the plurality of rosettes (operation 820). In some illustrative examples, each rosette is approximately equally offset from neighboring rosettes.

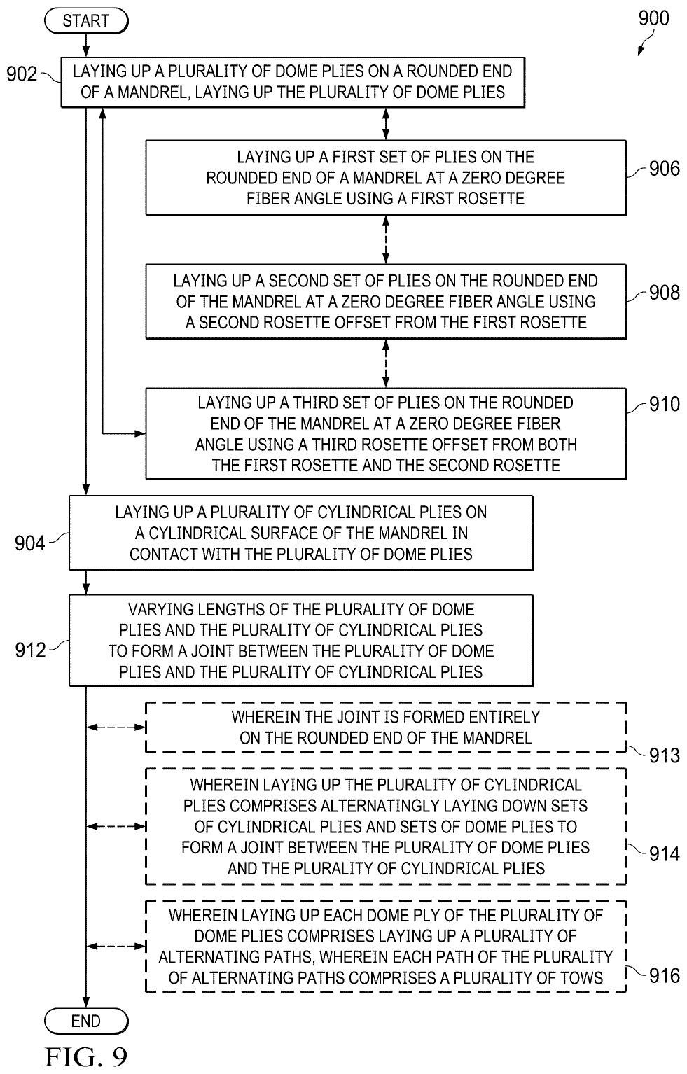

Turning now to FIG. 9, a flowchart of a method of laying up a composite structure is depicted in accordance with an illustrative embodiment. Method 900 can be performed to layup unitary 104 composite structure 102 of FIG. 1. Method 900 can be performed to layup unitary composite structure 202 of FIG. 2. Laying up dome ply 302 of FIG. 3 can be done during method 900. Laying up dome ply 402 of FIG. 4 can be done during method 900. Laying up dome ply 502 of FIG. 5 can be done during method 900. Method 900 can be performed to form layup 601 of FIG. 6. Method 900 can be performed to form layup 701 of FIG. 7.

Method 900 lays up a plurality of dome plies on a rounded end of a mandrel (operation 902). In method 900, laying up the plurality of dome plies comprises laying up a first set of plies on a rounded end of a mandrel at a zero degree fiber angle using a first rosette (operation 906). In method 900, laying up the plurality of dome plies comprises laying up a second set of plies on the rounded end of the mandrel at a zero degree fiber angle using a second rosette offset from the first rosette (operation 908). In method 900, laying up the plurality of dome plies comprises laying up a third set of plies on the rounded end of the mandrel at a zero degree fiber angle using a third rosette offset from both the first rosette and the second rosette (operation 910).

Method 900 lays up a plurality of cylindrical plies on a cylindrical surface of the mandrel in contact with the plurality of dome plies (operation 904). Method 900 varies lengths of the plurality of dome plies and the plurality of cylindrical plies to form a joint between the plurality of dome plies and the plurality of cylindrical plies (operation 912). By varying the lengths of the plurality of dome plies and the plurality of cylindrical plies, any desirable type of joint can be formed. Afterwards, method 900 terminates.

In some illustrative examples, the joint is formed entirely on the rounded end of the mandrel (operation 913).

In some illustrative examples, laying up the plurality of cylindrical plies comprises alternatingly laying down sets of cylindrical plies and sets of dome plies to form a joint between the plurality of dome plies and the plurality of cylindrical plies (operation 914). The sets of cylindrical plies and the sets of dome plies are laid up in concert such that the joint is formed.

In some illustrative examples, laying up each dome ply of the plurality of dome plies comprises laying up a plurality of alternating paths, wherein each path of the plurality of alternating paths comprises a plurality of tows (operation 916). Each of the plurality of alternating paths comprises the same plurality of tows. In some illustrative examples, the plurality of tows comprises at least 16 tows.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 806 through operation 820 may be optional. As another example, operation 906 through operation 916 may be optional.

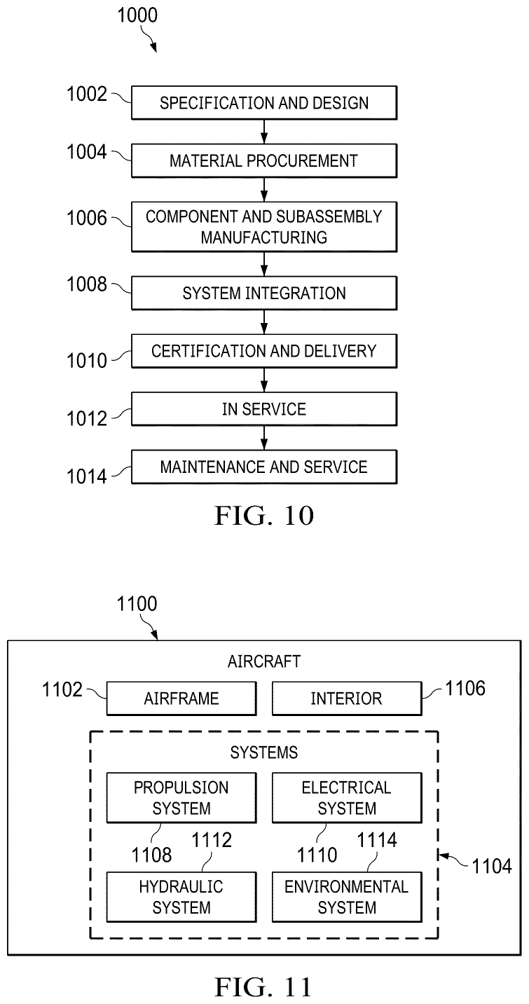

Illustrative embodiments of the present disclosure may be described in the context of aircraft manufacturing and service method 1000 as shown in FIG. 10 and aircraft 1100 as shown in FIG. 11. Turning first to FIG. 10, an illustration of an aircraft manufacturing and service method in a form of a block diagram is depicted in accordance with an illustrative embodiment. During pre-production, aircraft manufacturing and service method 1000 may include specification and design 1002 of aircraft 1100 in FIG. 11 and material procurement 1004.

During production, component and subassembly manufacturing 1006 and system integration 1008 of aircraft 1100 takes place. Thereafter, aircraft 1100 may go through certification and delivery 1010 in order to be placed in service 1012. While in service 1012 by a customer, aircraft 1100 is scheduled for routine maintenance and service 1014, which may include modification, reconfiguration, refurbishment, or other maintenance and service.

Each of the processes of aircraft manufacturing and service method 1000 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 11, an illustration of an aircraft in a form of a block diagram is depicted in which an illustrative embodiment may be implemented. In this example, aircraft 1100 is produced by aircraft manufacturing and service method 1000 of FIG. 10 and may include airframe 1102 with plurality of systems 1104 and interior 1106. Examples of systems 1104 include one or more of propulsion system 1108, electrical system 1110, hydraulic system 1112, and environmental system 1114. Any number of other systems may be included.

Apparatuses and methods embodied herein may be employed during at least one of the stages of aircraft manufacturing and service method 1000. One or more illustrative embodiments may be manufactured or used during at least one of component and subassembly manufacturing 1006, system integration 1008, in service 1012, or maintenance and service 1014 of FIG. 10.

The illustrative examples provide methods of fiber placing an integral dome/cylinder structure using a hybrid rosette. In some illustrative examples, a method cantilevers the dome/cylinder tool. The illustrative examples fiber place the dome cover plies with a 0 degree rosette perpendicular to the axis of symmetry. Each of the multiple rosettes are rotated about the surface normal at the apex of the dome (the axis of symmetry, or the Z axis of the reference rosette). The illustrative examples fiber place the cylinder plies with a 0 degree rosette parallel to the axis of symmetry. The illustrative examples stagger the interfaces of the plies across the dome to blend the effects. The illustrative examples co-cure the dome/cylinder structure.

In the illustrative examples, the dome plies have separate rosette references. In the illustrative examples, the dome plies are ‘clocked’ a desired amount. In some non-limiting illustrative examples, the dome plies are ‘clocked’ 22.5 deg increments (0, 22.5, 45, 67.5, 90, 112.5, 135, 157.5) in order to maintain a desirable ‘angle gap’ through thickness. In some illustrative examples, maintaining a desirable angle gap comprises minimizing the variation. The angle gap is a largest angle between adjacent fiber directions through the thickness. In some illustrative examples, ply interfaces are separated by 0.5″. In other illustrative examples, ply interfaces can be separated by greater than or less than 0.5″.

In some illustrative examples, next sequential interfaces are positioned in between the previous in order to distribute the interfaces through thickness. Any desirable quantity of effective fiber angles can be present in the dome portion. In some illustrative examples, the dome portion includes 4 orientations. In some illustrative examples, the dome portion includes 6 orientations. In some illustrative examples, the dome portion includes at least 8 orientations (i.e., 22.5 degree increments) to reduce angle gaps. More angles will give you more uniform properties.

The illustrative examples present a cylinder and dome fiber placed as one piece with 2 separate layup techniques. The illustrative examples utilize a cantilevered tool on rotator. The illustrative examples include a dome and cylinder laid up at the same time. In some illustrative examples, a cylinder is laid up first. The head of an automated placement system is rotated for the dome. The cylinder and dome have separate rosette references. Dome plies are ‘clocked’ at approximately equal increments. In some illustrative examples, the increments can be 0, 22.5, 45, 67.5, 90, 112.5, 135, 157.5. In some illustrative examples, the increments are selected in order to maintain minimal ‘angle gap’ through thickness. Angle gap equals the difference in fiber angle of two adjacent fiber directions through the thickness.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of laying up a unitary composite structure, comprising:
laying up a plurality of dome plies on a rounded end of a mandrel using a plurality of rosettes;
laying up a plurality of cylindrical plies on a cylindrical surface of the mandrel using a layup rosette independent of the plurality of rosettes; and
forming a transition region comprising a joint between the plurality of dome plies and the plurality of cylindrical plies by varying lengths of the plurality of dome plies and lengths of the plurality of cylindrical plies.

2. The method of claim 1, wherein laying up the plurality of dome plies comprises laying up a plurality of sets of plies, wherein each set of plies of the plurality of sets of plies is laid up at a zero degree fiber angle according to a respective rosette of the plurality of rosettes.

3. The method of claim 1, wherein laying up each dome ply of the plurality of dome plies comprises laying up a plurality of alternating paths, wherein each path of the plurality of alternating paths comprises a plurality of tows.

4. The method of claim 1, wherein forming the transition region comprises forming the joint entirely on the rounded end of the mandrel.

5. The method of claim 1, wherein forming the transition region comprises alternatingly laying up the plurality of dome plies and the plurality of cylindrical plies to form the joint.

6. The method of claim 1, wherein the plurality of rosettes comprises at least four rosettes.

7. The method of claim 1 further comprising:
curing the plurality of dome plies and the plurality of cylindrical plies on the mandrel.

8. The method of claim 1 further comprising:
dividing one hundred and eighty into equal increments to set a clocking offset for the plurality of rosettes.

9. The method of claim 1, wherein laying up the plurality of cylindrical plies comprises rotating the mandrel during layup of the plurality of cylindrical plies.

10. A unitary composite structure comprising:
a dome portion comprising a plurality of sets of plies laid up using a plurality of rosettes;
a cylindrical portion laid up with a layup rosette independent of the plurality of rosettes; and
a transition region between the dome portion and the cylindrical portion formed by varying lengths of plurality of dome plies of the dome portion and varying lengths of plurality of cylindrical plies of the cylindrical portion.

11. The unitary composite structure of claim 10, wherein the unitary composite structure has a half capsule shape comprising a cap and a body joined by a junction;
wherein the cap comprises the dome portion, the transition region, and an edge of the cylindrical portion; and
wherein the body is formed by the cylindrical portion.

12. The unitary composite structure of claim 10, wherein the transition region comprises a double scarf joint formed by alternatingly laid sets of cylindrical plies and sets of dome plies.

13. The unitary composite structure of claim 10, wherein the dome portion comprises a quantity of fiber angles equal to a quantity of rosettes in the plurality of rosettes.

14. The unitary composite structure of claim 10, wherein fiber angles of the dome portion are approximately equally offset from each other.

15. The unitary composite structure of claim 10, wherein the plurality of rosettes comprises at least four rosettes.

16. The unitary composite structure of claim 10, wherein a fiber angle gap of the dome portion is less than 45 degrees.

17. A method of laying up a composite structure comprising:
laying up a plurality of dome plies on a rounded end of a mandrel, laying up the plurality of dome plies comprising:
laying up a first set of plies on a rounded end of a mandrel at a zero degree fiber angle using a first rosette;
laying up a second set of plies on the rounded end of the mandrel at a zero degree fiber angle using a second rosette offset from the first rosette; and
laying up a third set of plies on the rounded end of the mandrel at a zero degree fiber angle using a third rosette offset from both the first rosette and the second rosette;
laying up a plurality of cylindrical plies on a cylindrical surface of the mandrel in contact with the plurality of dome plies; and
varying lengths of the plurality of dome plies and the plurality of cylindrical plies to form a joint between the plurality of dome plies and the plurality of cylindrical plies.

18. The method of claim 17, wherein the joint is formed entirely on the rounded end of the mandrel.

19. The method of claim 17, wherein laying up the plurality of cylindrical plies comprises alternatingly laying down sets of cylindrical plies and sets of dome plies to form a joint between the plurality of dome plies and the plurality of cylindrical plies.

20. The method of claim 17, wherein laying up each dome ply of the plurality of dome plies comprises laying up a plurality of alternating paths, wherein each path of the plurality of alternating paths comprises a plurality of tows.
